(19) United States
(12) Patent Application Publication
(10) Pub. No.: US 2025/0083497 A1
(43) Pub. Date: Mar. 13, 2025

(54) Harm Deflector

(71) Applicant: Lee Goodwyn, JR., Colonial Heights, VA (US)

(72) Inventor: Lee Goodwyn, JR., Colonial Heights, VA (US)

(21) Appl. No.: 18/435,881

(22) Filed: Feb. 7, 2024

Related U.S. Application Data
(60) Provisional application No. 63/538,053, filed on Sep. 12, 2023.

(51) Int. Cl. B60J 1/20

(52) U.S. Cl. CPC B60J 1/20

(57) ABSTRACT

A device may include an elongate member. A device may include at least one vehicle coupler configured to couple the elongate member adjacent an edge of a vehicle window in an orientation in which the length of the elongate member projects from a surface of the vehicle at an angle. A device may include at least one aerodynamic alteration feature coupled to or integrated with the elongate member, the aerodynamic alteration feature configured to alter the airflow over the surface of the elongate member.

### REFERENCE TO RELATED APPLICATIONS

This application claims priority to U.S. Provisional Application No. 63/538,053, entitled HARM DEFLECTOR, filed on Sep. 12, 2023 to Inventor Lee Goodwyn Jr., which is herein incorporated by reference in its entirety.

### FIELD OF THE INVENTION

The disclosure relates to deflectors attachable to vehicles.

### BACKGROUND OF THE INVENTION

Pets, especially dogs love to stick their heads out of car windows to see what's going on outside of the car. As anyone who has traveled in a vehicle without a windshield will tell you, bugs and other items in the air become fast moving projectiles. These projectiles can be annoying at best, and harmful at worst.

Conventionally, a solution to the problem has been to install a screen over the window of the car, but these screens don't allow pets to see out of the car as well as if they just stick their heads out of the window. These screens, besides blocking the dog's view, are complicated to install and remove making the person less likely to use them.

### SUMMARY OF THE INVENTION

This Summary is provided to introduce a selection of concepts in a simplified form that are further described below in the Detailed Description. This Summary is not intended to identify key or essential features.

In some aspects, the techniques described herein relate to a deflector assembly for a vehicle window, including: an elongate member; at least one vehicle coupler configured to couple the elongate member adjacent an edge of a vehicle window in an orientation in which the length of the elongate member projects from a surface of the vehicle at an angle; and at least one aerodynamic alteration feature coupled to or integrated with the elongate member, the aerodynamic alteration feature configured to alter the airflow over the surface of the elongate member.

In some aspects, the techniques described herein relate to a deflector assembly for a vehicle window, including: a deflector member; a rain guard member integrated with the deflector member; at least one vehicle coupler configured to couple the deflector member and the rain guard member adjacent two edges of a vehicle window in an orientation in which the length of the elongate member projects from a surface of the vehicle at an angle; and at least one aerodynamic alteration feature coupled to or integrated with the elongate member, the aerodynamic alteration feature configured to alter the airflow over the surface of the elongate member.

In some aspects, the techniques described herein relate to a deflector assembly for a vehicle window, including: a deflector member; a rain guard member releasably affixable with the deflector member; at least one vehicle coupler configured to couple the deflector member and the rain guard member adjacent two edges of a vehicle window in an orientation in which the length of the elongate member projects from a surface of the vehicle at an angle; and at least one aerodynamic alteration feature coupled to or integrated with the elongate member, the aerodynamic alteration feature configured to alter the airflow over the surface of the elongate member.

### BRIEF DESCRIPTION OF THE FIGURES

In order that the invention may be readily understood and put into practical effect, reference will now be made to exemplary embodiments as illustrated with reference to the accompanying drawings, where like reference numerals refer to identical or functionally similar elements throughout the separate views. The figures together with a detailed description below, are incorporated in and form part of the specification, and serve to further illustrate the embodiments and explain various principles and advantages, in accordance with the illustrative embodiments where:

FIG. 1 is a perspective view of a protector/deflector to protect dogs against projectiles in accordance with illustrative embodiments.

FIG. 2 is a perspective view of the protector/deflector of FIG. 1 installed on a vehicle window.

FIG. 3 is a symbolic representation of a protector/deflector and its angle relative to a vehicle surface.

FIG. 4 is a perspective view of an alternative embodiment of a protector/deflector.

FIG. 5 is a perspective view of a rain guard in accordance with an alternative embodiment and couplable with the deflector of FIG. 4.

It may be noted that to the extent possible, like reference numerals have been used to represent like elements in the drawings. Further, skilled artisans will appreciate that elements in the drawings are illustrated for simplicity and may not have been necessarily been drawn to scale. For example, the dimensions of some of the elements in the drawings may be exaggerated relative to other elements to help to improve understanding of aspects of the present invention. Furthermore, one or more elements may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

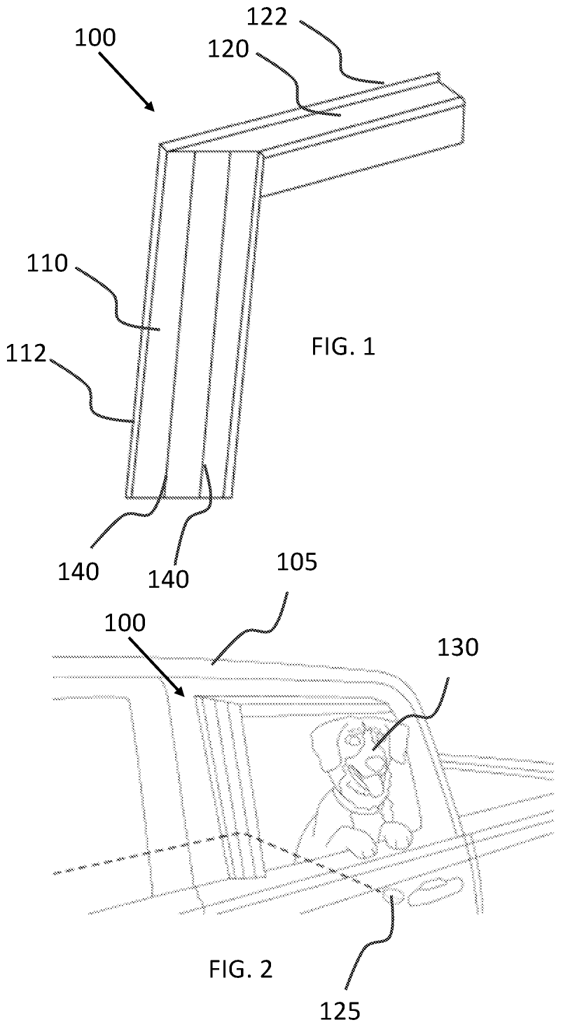

Referring to FIG. 1 and FIG. 2 an illustrative embodiment of a deflector (protector) 100 for a vehicle 105, is depicted. In some embodiments deflector 100 is a one-piece device. In other embodiments deflector 100 may be formed of more than one piece which couple together. In either case deflector 100 may include a substantially vertical deflector member 110 and a substantially horizontal rain guard member 120. Deflector 100 provides vertical deflector member 110 to protect dogs against projectiles 125 when they put their noses out of a vehicle window while the vehicle is in motion. Rain guard member 120 primarily prevents rain from dropping on dog 130 or any other human, animal, or object sticking out of the vehicle 105 as well as keeping rain from getting into the vehicle. Deflector member 110 includes one or more vertical diffuser ridges 140 on the surface of deflector member 110, which helps to diffuse or interrupt the air flow coming around the vertical deflector/protector. One or more ridges 140 may be used without departing from the scope of the disclosure. Varying size, number and shape of ridges 140 provide various performance characteristics in terms of level of protection, amount of drag caused by deflector 100, and level of noise. Ridges 140 may also be other features which alter the aerodynamic properties of deflector 100. Such features include but are not limited to grooves, bumps, dimples, etc.

In various illustrative embodiments, deflector member 110 may include a lip 112 that is configured to couple within the vehicle window groove or alternatively may be configured to provide extra surface area to stick to the outside of the vehicle. Similarly, rain guard 120 may include a lip 122 configured to couple with either the window groove or the outside of the vehicle.

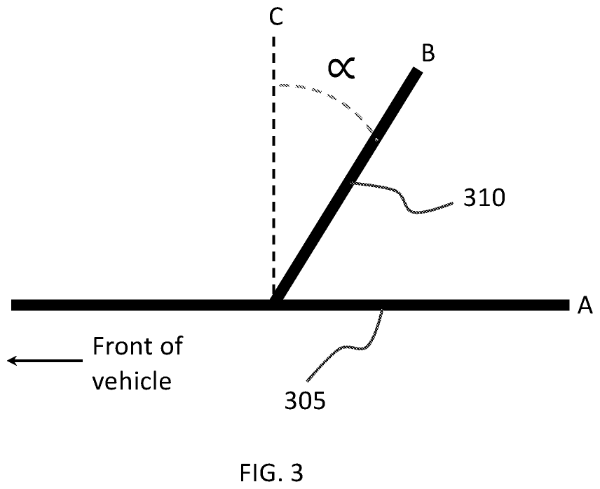

Referring now to FIG. 3, line A is representative of a cross section of the surface 305 of a vehicle looking from the bottom toward the top of the vehicle. Line B is representative of a cross-section of a deflector member 310 coupled at the forward edge of a window of the vehicle. In various illustrative embodiments, deflector member 310 may be configured to be at an angle α relative to a line C which is orthogonal to vehicle surface 305. Angle α may be configured as a variety of angles such as any from 0 to 60 degrees without departing from the scope of the disclosure. However, some values of a provide better performance in terms of air flow, drag, and sound. For example, computational fluid dynamics modelling has shown good performance with a at around 25 degrees. Such modelling has specific assumptions and parameters so an optimal value of a is dependent on those parameters. Accordingly, designers may choose any variety of angles α without limitation even if angle α does not provide optimal performance.

The design of the deflector such as but not limited to the deflector depicted in FIGS. 1 and 2, establishes a protective barrier. The increased wind velocity over the deflector assists in diverting dust and debris commonly encountered on the road. In some embodiments, this aerodynamic effect is most effective within the speed range of 25 to 75 miles per hour, aligning with North American speed limits. In various illustrative embodiments, the design ensures that it does not impede the driver's vision, maintaining safety without compromising visibility.

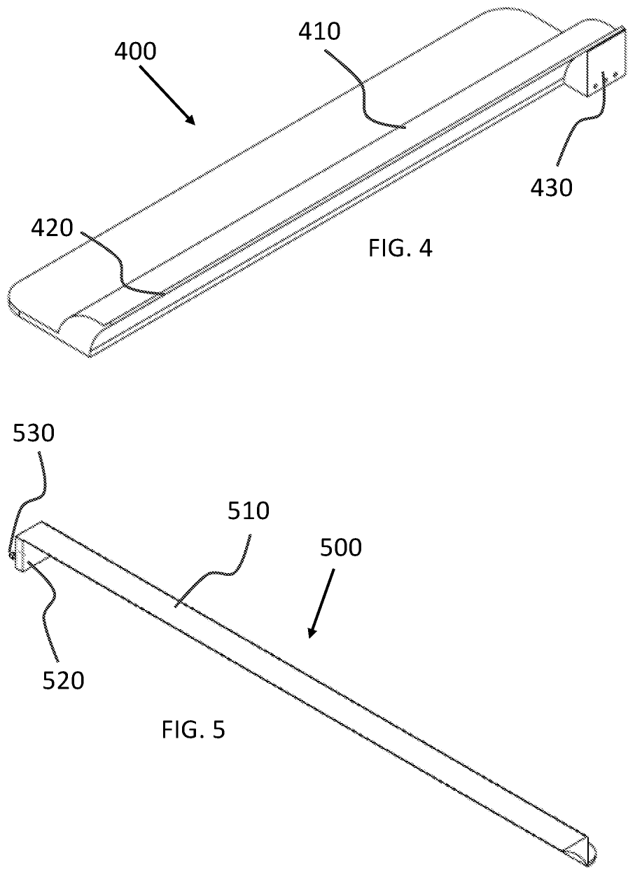

Referring now to FIG. 4, another illustrative embodiment of a deflector 400 is depicted. Deflector 400 includes a vertical deflector member 410 with a single ridge/diffuser 420 near the outer edge. Referring also to FIG. 5, a horizontal rain guard 500 includes a guard portion 510 and a connecting flange 520. Connecting flange 520 holds connectors 530 which may be pins, threaded shafts, or other connectors configured to connecting flange 430 of deflector 400. Thus, deflector 400 may be used as just a vertical deflector to help protect a dog etc., deflector 400 can be used as a standalone rain guard 500, or deflector 400 and rain guard 500 can be connected to be used together.

### Materials

Utilizing Polymethyl Methacrylate (PMMA) to form the deflector offers optical clarity, weather resistance, and UV stability, ensuring both clear vision and durability. This material is widely used due to its common availability. With an average cost of around one dollar per kilogram, PMMA proves economically advantageous for mass production, contributing to the affordability and accessibility of products incorporating this material. Many other materials may be equally applicable without departing from the scope of the disclosure.

### Current Technology

In accordance with illustrative embodiments, versatile deflector also functions as a rain guard, offering adaptability in terms of size and form factors to suit various vehicles. Notably, the incorporation of advanced techniques like Computational Fluid Dynamics (Aerodynamic analysis) in the design process provides an unparalleled level of design validation and advantage, setting it apart from traditional rain guard manufacturers.

### Summary and Conclusions

The deflector serves as a protective measure, effectively preventing debris from colliding with pets during car travel. Its design facilitates streamlined and cost-effective manufacturing, ensuring efficiency in production. The chosen properties for the deflector not only present a proven concept but also showcase an innovative design. The high level of design and engineering efforts employed in this technology places it on par with, if not surpassing, the capabilities of leading manufacturers in the rain guard industry.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment”, and similar language throughout this specification may, but do not necessarily, all refer to the same embodiment.

The terms “comprises”, “comprising”, or any other variations thereof, are intended to cover a non-exclusive inclusion, such that one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

While specific language has been used to describe the disclosure, any limitations arising on account of the same are not intended. As would be apparent to a person in the art, various working modifications may be made to the method in order to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. The scope of embodiments is by no means limited by these specific examples.

1. A deflector assembly for a vehicle window, comprising:
an elongate member;
at least one vehicle coupler configured to couple the elongate member adjacent an edge of a vehicle window in an orientation in which the length of the elongate member projects from a surface of the vehicle at an angle; and
at least one aerodynamic alteration feature coupled to or integrated with the elongate member, the aerodynamic alteration feature configured to alter the airflow over the surface of the elongate member.

2. The deflector assembly for a vehicle window of claim 1, further comprising:
a rain guard member configured to couple to the vehicle adjacent a top edge of the vehicle window.

3. The deflector assembly for a vehicle window of claim 2, wherein the rain guard includes a deflector coupler configured to aid in coupling the rain guard to the elongate member.

4. The deflector assembly for a vehicle window of claim 2, wherein the elongate member includes a rain guard coupler configured to aid in coupling the rain guard to the elongate member.

5. The deflector assembly for a vehicle window of claim 1, wherein the vehicle coupler includes a lip configured to engage with a window channel of the vehicle window.

6. The deflector assembly for a vehicle window of claim 1, wherein the vehicle coupler includes a lip configured with an adhesive for coupling with the vehicle surface.

7. The deflector assembly for a vehicle window of claim 1, wherein the vehicle coupler includes a lip configured with at least one magnet for coupling with the vehicle surface.

8. The deflector assembly for a vehicle window of claim 2, wherein the rain guard includes a lip configured to engage with a window channel of the vehicle window.

9. The deflector assembly for a vehicle window of claim 2, wherein the rain guard includes a lip configured with an adhesive for coupling with the vehicle surface.

10. The deflector assembly for a vehicle window of claim 2, wherein the rain guard includes a lip configured with at least one magnet for coupling with the vehicle surface.

11. The deflector assembly for a vehicle window of claim 1, wherein the at least one aerodynamic alteration feature includes at least one rib.

12. The deflector assembly for a vehicle window of claim 1, wherein the at least one aerodynamic alteration feature includes exactly one rib.

13. The deflector assembly for a vehicle window of claim 1, wherein the at least one aerodynamic alteration feature includes a plurality of bumps.

14. The deflector assembly for a vehicle window of claim 1, wherein the at least one aerodynamic alteration feature includes a plurality of dimples.

15. The deflector assembly for a vehicle window of claim 1, wherein the at least one aerodynamic alteration feature includes at least one groove.

16. The deflector assembly for a vehicle window of claim 1, wherein a surface of the elongate member is substantially planar.

17. The deflector assembly for a vehicle window of claim 1, wherein a surface of the elongate member is at least partially curved.

18. A deflector assembly for a vehicle window, comprising:
a deflector member;
a rain guard member integrated with the deflector member;
at least one vehicle coupler configured to couple the deflector member and the rain guard member adjacent two edges of a vehicle window in an orientation in which the length of the elongate member projects from a surface of the vehicle at an angle; and
at least one aerodynamic alteration feature coupled to or integrated with the elongate member, the aerodynamic alteration feature configured to alter the airflow over the surface of the elongate member.

19. The deflector assembly for a vehicle window of claim 18, wherein the at least one aerodynamic alteration feature includes at least one rib.

20. A deflector assembly for a vehicle window, comprising:
a deflector member;
a rain guard member releasably affixable with the deflector member;
at least one vehicle coupler configured to couple the deflector member and the rain guard member adjacent two edges of a vehicle window in an orientation in which the length of the elongate member projects from a surface of the vehicle at an angle; and
at least one aerodynamic alteration feature coupled to or integrated with the elongate member, the aerodynamic alteration feature configured to alter the airflow over the surface of the elongate member.
